(19) United States
(12) Patent Application Publication
(10) Pub. No.: US 2011/0091243 A1
(43) Pub. Date: Apr. 21, 2011

(54) Image Forming Apparatus

(76) Inventors: Toshiaki Tomino, Tokyo (JP); Hiroshi Isokawa, Tokyo (JP); Shinichi Tsukamura, Uenohara-shi (JP); Tetsuya Ishikawa, Tokyo (JP)

(21) Appl. No.: 12/899,366

(22) Filed: Oct. 6, 2010

(30) Foreign Application Priority Data
Oct. 15, 2009 (JP) JP2009-238015

(51) Int. Cl. G03G 21/00

(52) U.S. Cl. 399/123; 399/351; 399/349; 399/350

(57) ABSTRACT

An image forming apparatus including: an image carrier, rotating in a first direction and a second direction, and the second direction is opposite to the first direction; a transfer device for transferring the toner image; a cleaning device comprising a cleaning blade for cleaning the image carrier; and a cleaning blade exchanging section for exchanging the cleaning blade, wherein the apparatus works in such ways that, after the cleaning blade exchanging section has retracted the cleaning blade to a retracted position, the cleaning blade exchanging section rotates the image carrier in the second direction, whereby any foreign material, adhered onto the image carrier while the cleaning blade is exchanged, is moved upstream of the cleaning position of the cleaning blade, then the cleaning blade is pressed against the image carrier, and the image carrier is subsequently rotated in the first direction, so that the image carrier is cleaned.

### CROSS REFERENCE TO RELATED APPLICATION

This application is based on Japanese Patent Application No. 2009-238,015 filed on Oct. 15, 2009 with the Japanese Patent Office, the entire content of which is hereby incorporated by reference.

### TECHNICAL FIELD

The present invention relates to an image forming apparatus which forms images by the electro-photographic process, and in particular, to an improvement of technology for cleaning an image carrier which carries toner images.

### BACKGROUND ART

In the image forming apparatuses which form the images by the electro-photographic process, as a cleaning means for removing toner particles from the image carriers, such as a photoconductor and an intermediate transfer body, rubber cleaning blades are widely used.

Due to the high performance and high endurance of the image forming apparatuses using the electro-photographic process, the image forming apparatuses have been used in the printing fields. Further, concerning cleaning devices, since the cleaning blade has a lower endurance than an image forming section, the cleaning blades have been treated as exchanging parts.

In Unexamined Japanese Patent Application Publication No. 6-148,974 (hereinafter, referred to as JP-A 6-148,974), a cleaning device is disclosed, in which a plurality of cleaning blades are housed, and a deteriorated cleaning blade is exchanged for new one.

However, around a position where the cleaning blade comes into contact with the image carrier, a small amount of toner particles tends to adhere to the image carrier, whereby said adhered toner particles cause lower image quality.

In paragraph [0003] of Unexamined Japanese Patent Application Publication No. 5-297,769 (hereinafter, referred to as JP-A 5-297,769), detailed are that, when the cleaning blade is retracted from the photoconductor, some toner particles remain on the photoconductor, and said toner particles deteriorate the image quality, whereby, the photoconductor is rotated in the opposite direction to overcome this problem.

Further, in JP-A 5-297,769, since toner particles accumulate on a brush, mounted between a cleaning device and an electronical charging device, said toner particles drop onto the photoconductor, so that the image quality is deteriorated. In order to overcome this problem, the photoconductor is rotated in the opposite direction, whereby a portion of the photoconductor, with which the brush came into contact, is moved toward upstream of the cleaning blade.

In the cleaning device, having a blade exchanging function, mounted in the image forming apparatus as shown in JP-A 6-148,974, since large size mechanical parts are driven in the cleaning device for exchanging the blade, foreign material, which has been adhered to the inside of the cleaning device, tend to be ejected, so that a large number of the foreign material adhere to the image carrier. Accordingly, as shown in JP-A 5-297,769, if the foreign material, adhered to the image carrier, is moved upstream of the cleaning blade, and if the cleaning operation is conducted after the next image forming operation, the adhered foreign material cannot be sufficiently cleaned off from the image carrier. Specifically, since the foreign material, accumulated within the cleaning device, include external additives and a large number of fine resin particles, the above method shown in JP-A 5-297,769 cannot sufficiently remove said foreign material, which results in undesired image quality.

### SUMMARY OF THE INVENTION

An object of the present invention is to offer a highly endurable image forming apparatus, being able to form a high quality image, in which deterioration of the image due to foreign material, scattered from the cleaning device during exchange of the blade, are prevented.

To achieve at least one of the abovementioned objects, an image forming apparatus, reflecting one aspect of the present invention, comprises: an image carrier for carrying a toner image, wherein the image carrier is configured to rotate in a first direction and a second direction, and the second direction is opposite to the first direction; a transfer device for transferring the toner image, carried on the image carrier rotating in the first direction, onto the recording medium; a cleaning device comprising a cleaning blade for cleaning the image carrier from which the toner image has been transferred, wherein the cleaning device includes an exchangeable cleaning blade; and a cleaning blade exchanging section for exchanging the cleaning blade, wherein the image forming apparatus is configured to work in such ways that, after the cleaning blade exchanging section has retracted the cleaning blade a retracted position, the cleaning blade exchanging section rotates the image carrier in the second direction, so that any foreign material, adhered onto the image carrier while the cleaning blade is exchanged, is moved upstream of the cleaning position of the cleaning blade, with respect to the first direction, then, the cleaning blade, having been exchanged, is pressed against the image carrier, then, the image carrier is subsequently rotated in the first direction, so that the image carrier is cleaned.

### BRIEF DESCRIPTION OF THE DRAWINGS

Embodiments will now be detailed, by way of example only, with reference to the accompanying drawings which are meant to be exemplary, not limiting, and wherein like embodiments are numbered alike in the several figures, in which:

FIG. 1 is a drawing to show the total structure of an image forming apparatus relating to an embodiment of the present invention,

FIG. 2 is a drawing to show a structure of a cleaning device,

FIG. 3 is a frontal cross-sectional view of the cleaning device,

FIG. 4 is a cross-sectional view cut by line SS1-SS1 in FIG. 3,

FIG. 5 is a right side view of the cleaning device,

FIG. 6 is a cross sectional view cut by line SS2-SS2 in FIG. 3,

FIGS. 7a-7c are drawings to show the function of a cam mechanism,

FIGS. 8a-8c are drawings to show the function of a cleaning blade supporting shaft, rotating with the cam mechanism,

FIGS. 9a-9c are drawings to show the function of a rotating means of the cleaning blade supporting shaft,

FIG. 10 is a block chart of a control system, and

FIG. 11 is a flow chart for exchanging the cleaning blade.

### DETAILED DESCRIPTION OF THE PREFERRED EMBODIMENTS

The embodiments will now be detailed while referring to the drawings, however the present invention is not limited to these embodiments.

### [Image Forming Apparatus]

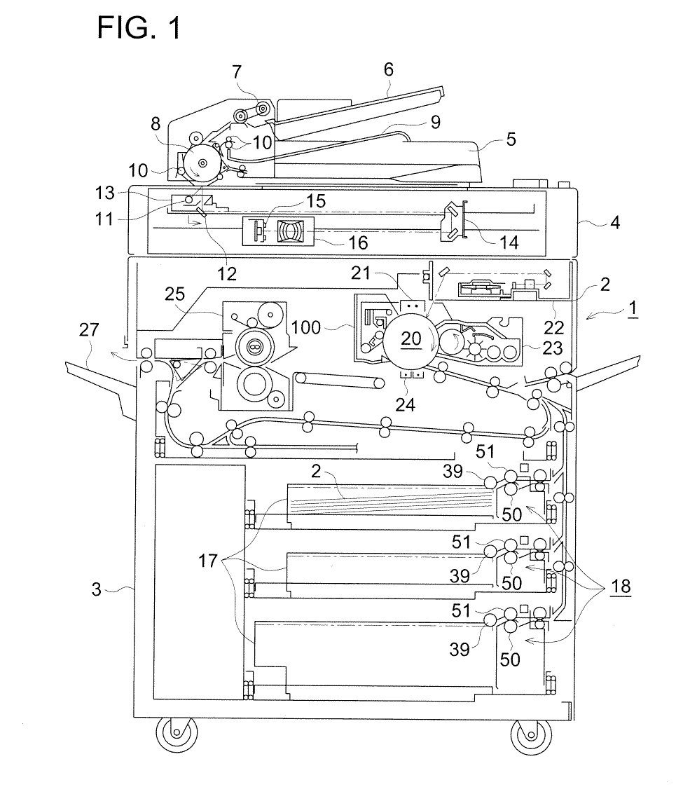

FIG. 1 is a thawing to show the total structure of the image forming apparatus relating to the embodiments of the present invention. Image forming apparatus 1 includes image forming section 2 for forming images on sheet P, and image reading section 4 for reading an image to be fowled on sheet P, from an original document, wherein image reading section 4 is mounted above image forming section 2. Further, automatic document feeding device 5, for automatically feeding the original document to image reading device 4, is mounted above image forming section 2.

Automatic document feeding device 5 has document housing 6 for flatly holding the original documents, and a document feeding roller 7, mounted on a one end of platen 6, for feeding the original documents one by one. Document supporting roller 8 is mounted on the left side below document housing 6, said roller 8 supports the original document and rotates. Original document ejecting plate 9 is mounted below document housing 6, the original document, having been read by image reading device 4, is ejected onto document ejecting plate 9. Further, paired document feeding rollers 10 are mounted within automatic document feeding device 5, wherein said paired rollers 10 convey the document from housing 6 to roller 8, after the original document has been conveyed along the circumference of roller 8, said document is ejected onto document ejecting plate 9.

Image reading device 4 is structured of first mirror unit 13 in which light source 11 for radiating light rays onto the original document, and mirror 12 for reflecting the light rays, reflected from the original document are united, and second mirror unit 14 for reflecting the light rays from first mirror unit 13. First mirror unit 13 and second mirror unit 14 are movable in the horizontal direction in FIG. 1. Further, image reading device 4 has imaging element 15, such as a CCD, for photo electrically converting the light rays. Lens 16, for focusing the light rays from second mirror unit 14 on imaging element 15, is mounted in front of imaging element 15.

A slit is mounted under document supporting roller 8, so that the light rays are radiated through the slit onto the original document, being conveyed along document supporting roller 8. Image reading device 4 makes first mirror unit 13 to be positioned under the slit, so that the image on the original document is read.

Further, automatic document feeding device 5 can be opened and closed on image reading device 4, and a platen glass is mounted on the upper surface of image reading device 4, so that the original document is placed. Image reading device 4 makes first mirror unit 13 and second mirror unit 14 to scan the images on the original document, placed on the platen glass, so that the images can be read.

Below image forming section 2, sheet supplying trays 17, accommodating stacked sheets P, are mounted in three stages. Sheet supplying means 18 is mounted above one end of each sheet supplying tray 17, so that sheets P can be picked up one by one, and supplied to image forming section 2. Sheet supplying means 18 is structured of feed-out roller 39 and a sheet separation section, including separating roller 50 and supplying roller 51.

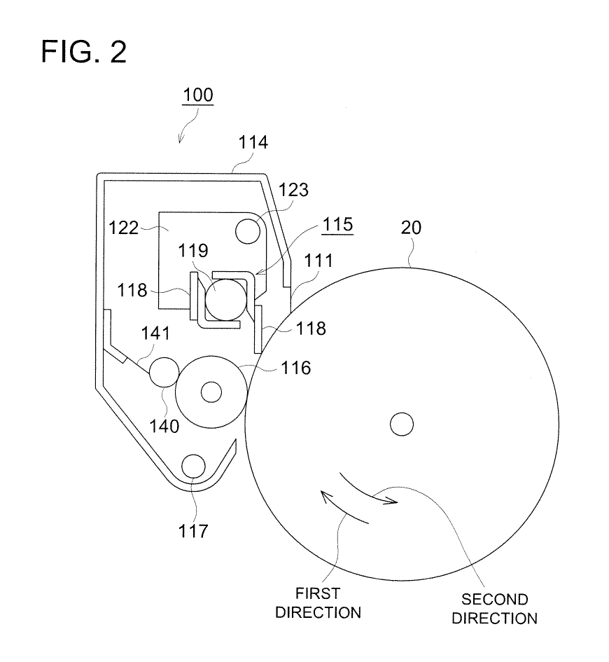

Above sheet supplying tray 17, image forming section 2 is mounted to form an image on sheet P. Image forming section 2 includes cylindrical photoconductor 20, serving as an image carrier to carry a toner image. Photoconductor 20 is rotated clockwise in FIG. 1 (being a first direction in FIG. 2), and counterclockwise (being a second direction in FIG. 2) by a drum driving mechanism, not illustrated.

Electro-charging device 21 is mounted above photoconductor 20. Electro-charging device 21 conducts the corona discharge onto the surface of photoconductor 20, so that the surface is evenly charged.

Around photoconductor 20, exposure device 22, including an exposure light source, such as laser diodes, is arranged more downstream than electrostatic-charging device 21, in the first rotating direction of photoconductor 20. Exposure device 22 conducts image exposure based on image signals, onto the surface of photoconductor 20, whereby the electric charges of the exposed portions on the surface of photoconductor 20 are decreased or dissolved, so that electrostatic latent images are formed.

Development device 23 is mounted more downstream than exposure device 22, in the first rotating direction of photoconductor 20. Using a reversal development method, developing device 23 develops the electrostatic latent images, formed on the surface of photoconductor 20, with the toner particles charged at the same polarity as photoconductor 20.

Transfer device 24 is mounted more downstream than development device 23, in the first rotating direction of photoconductor 20. A conveyance route for conveying sheet P is formed between transfer device 24 and photoconductor 20. While sheet P is pressed against photoconductor 20, transfer device 24 conducts the corona discharge from the reverse surface of sheet P, so that the toner images are transferred onto sheet P.

Image fixing device 25 is mounted downstream of the conveyance route from transfer device 24. The toner particles, carried on the surface of sheet P, are melted by heat on image fixing device 25, so that they are fixed onto sheet P.

Around photoconductor 20, cleaning device 10 is arranged to be more downstream than transfer device 24, in the first rotating direction of photoconductor 20. Cleaning device 100 removes the toner particles or paper powder remaining after the transfer, from the surface of photoconductor 20.

Sheet ejection tray 27 is mounted on one side of image forming apparatus 1, to receive sheet P carrying the formed images. Further, an operation display section, not illustrated, is mounted on the upper surface of image forming section 2, to receive instructions from the user.

### [Cleaning Device]

Cleaning device 100 will now be detailed below.

FIG. 2 shows a structure of cleaning device 100.

Cleaning device 100 is structured of cleaning unit 115, including two cleaning blades 118, each mounted on a common supporting shaft, rotating cleaning brush 116, toner particles conveying section 117 for conveying the toner particles, gathered by a cleaning operation, cleaning auxiliary member 111 for removing any residual toner particles on the surface of photoconductor 20, after cleaning conducted by cleaning blades 118, toner particle removing member 140, being a round bar, for removing the toner articles from cleaning brush 116; and scalper 141, made of a stainless steel, for scalping the toner particles from toner particle removing member 140.

Cleaning blade 118 has an edge portion for coming into contact with photoconductor 20, so that the edge portion removes toner particles and foreign material, both remaining on the surface of photoconductor 20. Cleaning auxiliary member 111, made of PET film, is adhered to housing 114 of cleaning device 100. Housing 114 hermitically seals various sections of cleaning device 100, other than an opening portion at which cleaning device 100 faces photoconductor 20, so that the toner particles cannot fly out.

Photoconductor 20 rotates clockwise (which is the first direction) during image formation. Cleaning blade 118 is configured to primarily clean photoconductor 20. Cleaning brush 116 is configured to clean photoconductor 20, upstream of the portion where the edge of cleaning blade 118 comes into contact with the surface of photoconductor 29, in the first rotating direction of photoconductor 20. Cleaning auxiliary member 111 is configured to clean photoconductor 20, downstream of the portion where the edge of cleaning blade 118 is in contact with the surface of photoconductor 29, in the first rotating direction of photoconductor 20. Accordingly, this cleaning structure can remove any remaining toner particles from the surface of photoconductor 20 more effectively, so that the images having high quality can be stably formed over a long time.

Photoconductor 20, carrying any remaining toner particles, external additive, such as lubricant agent, and paper powder, is rotated to contact cleaning device 100. Firstly, photoconductor 20 is cleaned by cleaning brush 116, and subsequently cleaned by cleaning blade 118. Remaining toner particles and paper powder can be removed by cleaning brush 116 and cleaning blade 118, however, small amount of very fine particles, such as external additive, separated from the toner particles, cannot be removed by cleaning blade 118. These very fine particles can forever be removed by cleaning auxiliary member 111.

The edge of cleaning blade 118 can be made to contact or be separated from photoconductor 20. Cleaning unit 115 is structured of paired cleaning blades 118. Said paired blades 118 are rotatable around blade supporting shaft 119, so that they can rotate. Cleaning blade 118 can be exchanged to another cleaning blade 118, when cleaning unit 115 is rotated.

Separation of cleaning blade 118 from photoconductor 20 and rotation of paired cleaning blades 118 will be detailed below. Cleaning blade supporting shaft 119, carrying paired cleaning blades 118, is mounted on shaft holder 122. Shaft holder 122 is rotatable around pressure-contact releasing shaft 123.

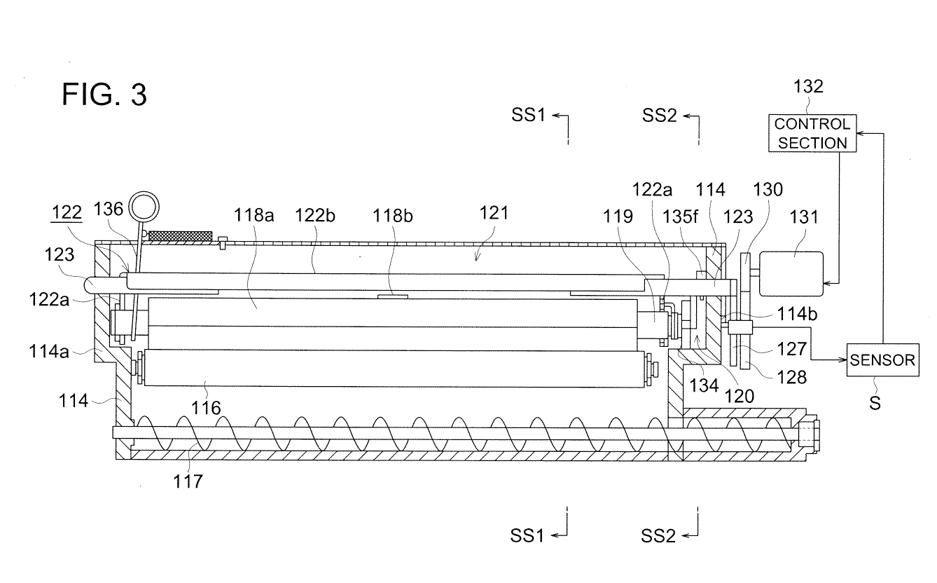

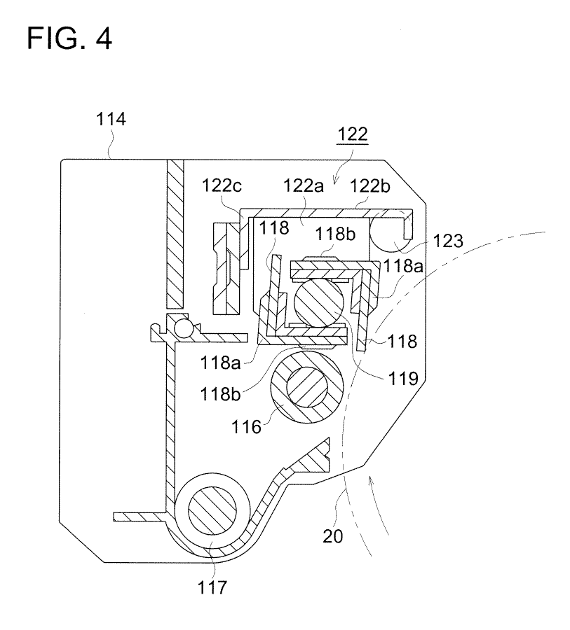

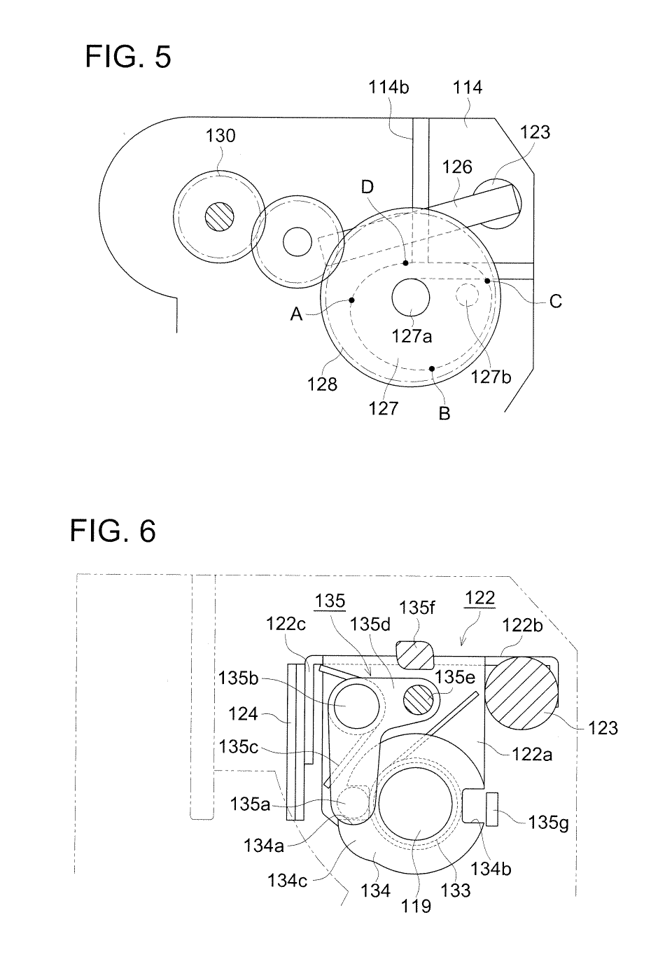

FIG. 3 is a frontal cross sectional view of cleaning device 100, FIG. 4 is a cross-sectional view cut by line SS1-SS1 in FIG. 3, while FIG. 5 is side view of cleaning unit 115, and FIG. 6 is a cross-sectional view cut by line SS2-SS2 in FIG. 3.

In FIG. 3, cleaning unit 115 includes blade supporting shaft 119, carrying paired cleaning blades 118, supporting shaft rotating section 120 for rotating blade supporting shaft 119 in a predetermined direction, and supporting shaft moving section 121 for making blade supporting shaft 119 to come into contact with or separate from photoconductor 20.

In FIG. 4, cleaning blade 118 is fixed by blade holder 118a, structured of two L-shaped members (as shown in the cross-sectional view), and cleaning blade 118 is mounted on blade supporting shaft 119 by supporting pin 118b, so that cleaning blade 118 can be rotated. In the present embodiment, two cleaning blades 118 are mounted at symmetrical positions of blade supporting shaft 119, however, more than two cleaning blades can be mounted.

In FIG. 3, blade supporting shaft 119 is rotatably supported by holder side plates 122a and 122b of shaft holder 122, wherein shaft holder 122 is included in supporting shaft moving section 121. Shaft holder 122 includes holder side plate 122a, holder top plate 122b (both shown in FIG. 3), and holder back plate 122c (shown in FIG. 4), wherein plates 122b and 122c are prolonged from plate 122a. In FIG. 3, two pressure-contact releasing shafts 123 and 123 protrude from holder top plate 122b to both side sections. Two pressure-contact releasing shafts 123 and 123 are rotatably supported by both side plates 114a and 114a of housing 114 (shown in FIG. 3). In FIG. 6, weight plate 124 is mounted on holder back plate 122c, so that weight plate 124 applies rotation momentum, whose rotation center is pressure contact-releasing shaft 123, on shaft holder 122 and cleaning blade supporting shaft 119. That is, weight plate 124 is configured to control the top of cleaning blade 118 to come into pressure-contact with the surface of photoconductor 20 at a constant pressure.

One end of pressure-contact releasing shaft 123 penetrates side plate 114a, to connect to cam mechanism 125, which mechanism 125 is included in supporting shaft moving section 121. Cam mechanism 125 is structured of arm 126 being fixed to the end of pressure-contact releasing shaft 123 to serve as a driven section, cam 127 to vertically move arm 126 to rotate pressure-contact releasing shaft 123, driven gear 128 to give rotation force to cam 127 through shaft 127a drive gear 130 to engage driven gear 128, and drive motor 131 to apply rotation force to drive gear 130 in a predetermined direction. Drive motor 131 is controlled by control section 132 to move supporting shaft moving section 121.

On the surface of cam 127 shown in FIG. 5, point A slightly pushes up arm 126. Point C pushes up arm 126 to the highest point. Point B is on a sloped surface between points A and C. Point D faces point B on the opposite surface between points A and C, wherein cam 127 exhibits a cam radius to separate arm 126 from cam 127 at point B. When cleaning blade 118 is in contact with photoconductor 20, that is, cleaning blade 118 is in a contacting position, the surface of the cam, facing arm 126, represents point D, so that arm 126 is separated from cam 127. When cleaning blade 118 separates from photoconductor 20, that is, cleaning blade is in a separated position, one of points A, B or C is in contact with arm 126. Among points A-D, point A represents a non-cleaning position, point C represents a blade exchanging position, and point D represents a blade contacting position. Cam 127 is set to face arm 126 on points A-D, and their angles on cam 127 are determined based on angles detected by sensor S, mounted on shaft 127a. Point A is a home position of cleaning blade 118, so that cleaning blade 118 is in slight contact with photoconductor 20. The home position is determined, when image forming apparatus 1 is in a stopped state, or before shipment. Point C is the blade exchanging position, so that cleaning unit 115 (see FIG. 2) is rotated to exchange blade 118. Point D is an image forming position, so that cleaning blade 118 is in contact with photoconductor 20.

Cam 127 is rotated by motor 131 to reach a predetermined angle. Due to overrunning of cam 127, if cam 127 is at once rotated from the non-contacting point with arm 126 (which is a blade contacting position to photoconductor 20) to the highest point (which is point C) to push up arm 126, drive motor 131 may malfunction due to the overload. Further, due to overrunning of cam 127, if cam 127 is at once rotated from point C, being the blade exchanging position, to the blade contacting position, cleaning blade 118 may strongly hit photoconductor 20, whereby both cleaning blade 118 and photoconductor may be damaged. In order to prevent these overrunning, locking portion 127b protrudes on a side surface of cam 127, and rib 114b is formed on the outer surface of side plate 114a of housing 114, so that locking portion 127b is stopped by rib 114b. Whichever directions cam 127 may be rotated, locking portion 127b is stopped by rib 114b, serving as a stopper, so that overrunning of cam 127 is prevented.

Next, while referring to FIG. 6 and other figures, supporting shaft rotating section 120 will now be detailed, which is configured to rotate blade supporting shaft 119 in a predetermined direction, to exchange cleaning blade 118. Blade supporting shaft 119 protrudes from holder side plate 122a of shaft holder 122 to the inner surface of side plate 114a of housing 114. Blade exchanging spring 133 is wound on one end of blade supporting shaft 119. Ratchet 134 to control the rotation of blade supporting shaft 119 is mounted at a top portion of blade exchanging spring 133.

Plural notched portions are formed on ratchet 134, being the same number as the number of blades 118, accordingly, two notched portions 134a and 134b are formed for two blades 118, in this embodiment. The external shape of ratchet 134 is approximately a round shape, however, convex portion 134c is formed on one of notched portion 134a to protrude from the round shape. Further, ratchet pawl 135 having cylindrical pin member 135a, exhibiting acceptable sizes to meet notched portions 134a and 134b, is formed on holder side plate 122a of shaft holder 122. Ratchet pawl 135 is structured of shaft 135b, rotatably supported on holder side plate 122a, ratchet spring 135c, wounded on shaft 135b for applying torque in a constant direction, and L-shape plate member 135d, whose center portion is fixed on the end of shaft 135b, wherein cylindrical pin member 135a protrudes on one end of L-shape plate member 135d. Cylindrical pin member 135a is inserted in notched portion 134a of ratchet 134 by an elastic force of ratchet spring 135c, whereby blade supporting shaft 119 is prevented from undesirably rotating by the elastic force of blade exchanging spring 133.

On the other end of L-shape plate member 135d, pin member 135e protrudes toward side plate 114a of housing 114. Stopper 135f protrudes on side plate 114a toward the top of pin member 135e. Said stopper 135f functions to push and stop pin member 135e of ratchet pawl 135 rotating with shaft holder 122. Stopper 135f further functions to make ratchet pawl 135 to rotate around shaft 135b, and to remove cylindrical pin member 135a from notched portion 134a.

When cylindrical pin member 135a is separated from notched section 134a, ratchet 134 rotates with blade supporting shaft 119 in a predetermined direction by the elastic force of blade exchanging spring 133. When convex portion 134c of ratchet 134 touches projection 135g projected from holder side plate 122a, ratchet 134 stops. Projection 135g is arranged at a position to separate from ratchet 134, but projection 135g can come into contact with convex portion 134c at said position. By ratchet 134 and ratchet pawl 135, when supporting shaft moving section 121 is at the blade separating position, or in more detail, only when said section 121 reaches the blade exchanging position, blade supporting shaft 119 can be rotated.

In addition, blade exchanging spring 133, included in supporting shaft rotating section 120, requires an elastic force which can rotate blade supporting shaft 119 carrying two cleaning blades 118. Said elastic force is charged by an outer force. As shown in the present embodiment, since wire 136 (see FIG. 3) is wound on an end of blade supporting shaft 119, elastic force can be charged, when wire 136 is pulled by the user.

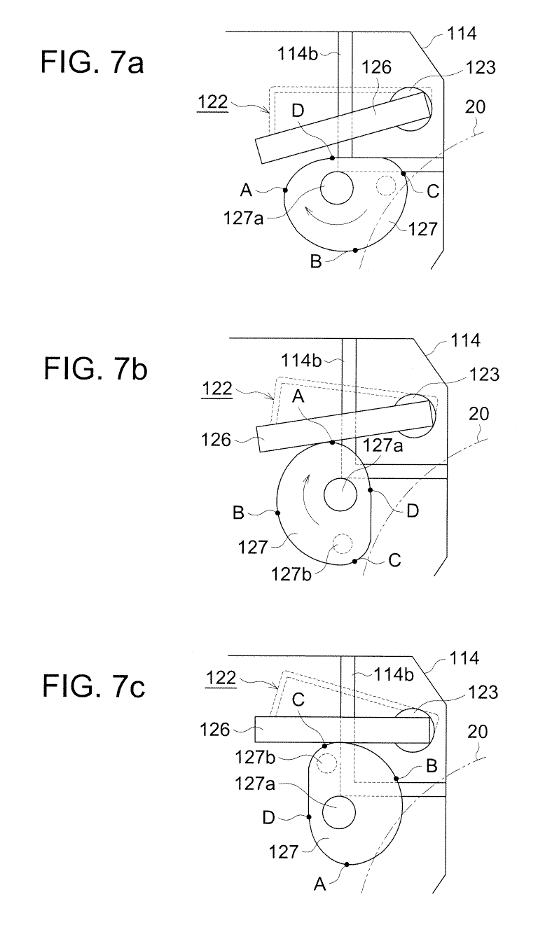

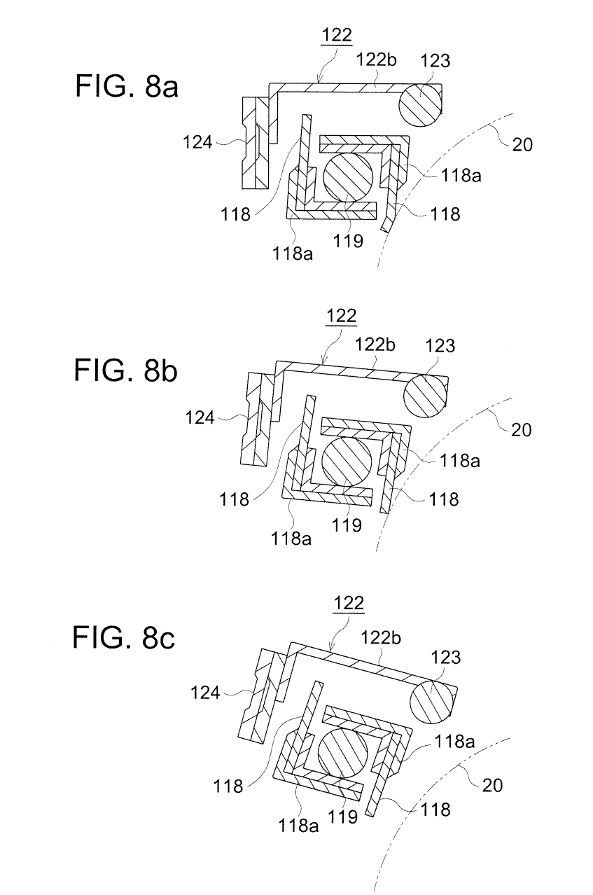

Cleaning device 100 will now be detailed. Firstly, the function of supporting shaft moving section will be detailed while referring to FIGS. 7 and 8. FIGS. 7a-7c show the function of cam mechanism 125, FIGS. 8a-8c show the function of shaft holder 122 and blade supporting shaft 119, both of which rotate when cam mechanism moves. FIG. 7a and FIG. 8a show that supporting shaft moving section 121 is at the blade contacting position, FIG. 7b and FIG. 8b show that said section 121 is at the non-cleaning position (being the home position), and FIG. 7c and FIG. 8c show that said section 121 is at the blade exchanging position.

When image forming apparatus 1 is activated, control section 132 controls drive motor 131 to rotate, so that arm 126 is separated from cam 127, and cleaning blade 113 comes into contact with photoconductor 20. When a predetermined time has passed after the image formation was completed, motor 131 rotates cam 127 so that arm 126 comes into contact with arm 126 at point A. Pressure-contact releasing shaft 123, mounted on arm 126, and shaft holder 122, connected to shaft 123 are rotated so as to correspond to the rotating angle of arm 126, whereby cleaning blade 118 comes into slight contact with photoconductor 20, which is shown in FIG. 8b.

When cleaning blade 118 is to be exchanged, after 300,000 prints have been formed, for example, control section 132 controls motor 131 to further rotate cam 127, whereby the contacting point moves from point A to point C through point B, and arrives at the blade exchanging position. In this case, the rotation angle is approximately 120 degrees. After cleaning blade 118 has been exchanged for another one, cam 127 rotates in the opposite direction, C→B→A, and returns to the non-cleaning position. When the next image formation is started, cleaning blade 118, having been exchanged, is made to contact photoconductor 20.

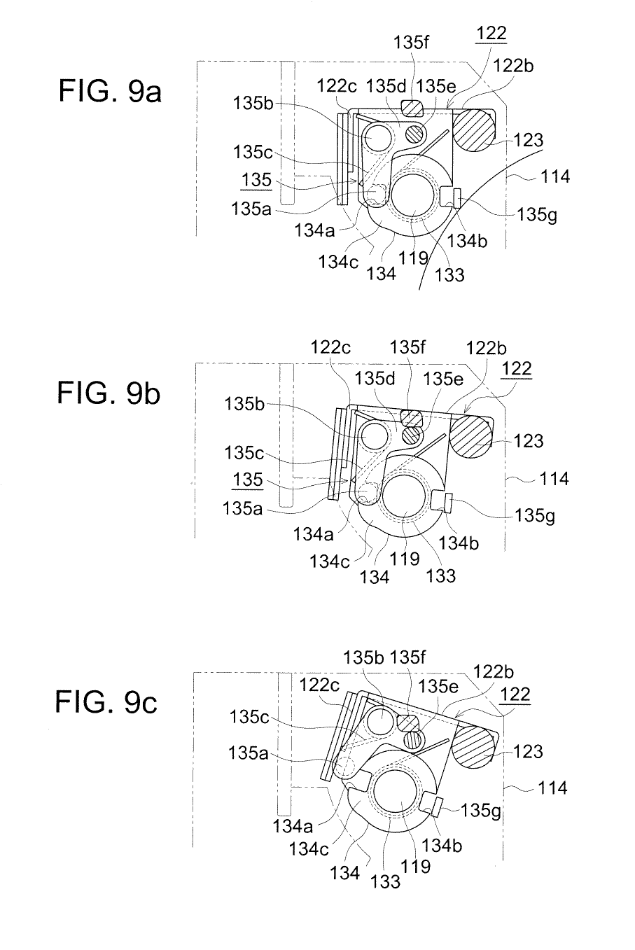

The function of supporting shaft rotating section 120, moving with supporting shaft moving section 121, will now be detailed, based on FIGS. 9a-9c, which are drawings to show the function of supporting shaft rotating section 120. FIG. 9a shows that supporting shaft rotating section 120 is at the blade contacting position, FIG. 9b shows that said section 120 is at the non-cleaning position, and FIG. 9c shows that said section 120 is at the blade exchanging position. When supporting shaft moving section 121 has rotated pressure-contact releasing shaft 123 to a predetermined angle, stopper 135f, protruded from side plate 114a of housing 114, comes into pressure-contact with pin member 135e of ratchet pawl 135, wherein said ratchet pawl 135 rotates with pressure-contact releasing shaft 123 and shaft holder 122 (see FIG. 9b). After that, pressure-contact releasing shaft 123 is rotated, ratchet pawl 135 is rotated around shaft 135b, and cylindrical pin member 135a is finally separated from notched portion 134a. At this time, ratchet 134 is rotated with blade supporting shaft 119 in a predetermined direction by the restoration force of blade exchanging spring 133, which has been charged. By the rotation of blade supporting shaft 119, cleaning blade 118 is exchanged for another one, and rotating ratchet 134 is stopped when convex portion 134c is stopped by projection 134g projecting from holder side plate 122a (FIG. 9c). Subsequently, supporting shaft moving section 121 makes pressure-contact releasing shaft 123 to rotate in the opposite direction to stop at the non-cleaning position, shaft 135b is rotated by the elastic force of ratchet spring 135c in the predetermined direction, so that cylindrical pin member 135a contacts notched portion 134b of ratchet 134, whereby the position of cleaning blade 118 is determined.

[Control during Cleaning Blade Exchanging Procedure]

As detailed above, since plural cleaning blades have been provided within cleaning device 100, the deteriorated cleaning blade can be exchanged for a new one, while the interior of image forming apparatus 1 is not opened. Accordingly, the durability of image forming apparatus 1 is extremely prolonged, so that said image forming apparatus 1, using the electro-photographic method, can be used as the printing apparatus.

In the blade exchanging procedure, after the cleaning blade has been retracted, the cleaning unit, unitizing the plural cleaning blades, is rotated.

In cleaning unit 100, not only the toner particles gathered by cleaning operation, but also the external additives, such as lubricant, and paper powder are accumulated. Though the toner particles are conveyed to the exterior of cleaning device 100 by toner conveying section 117, the toner particles, the external additive, such as the lubricant, and paper powder are adhered to the inner surface of housing 114 to be accumulated.

When the cleaning blade is to be exchanged, cleaning unit 115 is rotated at relatively large angle, so that the accumulated materials are ejected, and they tend to adhere to photoconductor 20.

Concerning the blade exchanging mechanism described above, cleaning unit 115 is rotated by the force of the spring to exchange cleaning blade 118. In this blade exchanging mechanism, since cleaning blade 118 is precisely positioned by the stopper, high cleaning characteristics can be stably controlled. Concerning the mechanism for rotating cleaning unit 115, mechanical shock due to the exchanging operation occurs, and foreign material in cleaning unit 100 are ejected. In order to use the ejection during the blade exchange, cleaning unit 115 is rotated plural turns, whereby the interior of cleaning unit 100 can be cleaned well.

Foreign material, having adhered to photoconductor 20, can be wiped by cleaning device 100, while photoconductor 20 is rotating during the next image formation after the cleaning blade has been exchanged. However, foreign material, adhered to photoconductor 20 during the blade exchanging operation, tend to be insufficiently cleaned off.

Deterioration of image quality, due to the above-described exchanging operation of the cleaning blade, can be effectively prevented by a control system detailed below.

While the exchanging operation of the cleaning blade, since photoconductor 20 is controlled to rotate in the second direction, any foreign material, ejected from cleaning device 100 and adhered to photoconductor 20, are moved upstream of cleaning device 100, and in particular, at least upstream of the cleaning position where cleaning blade 118 cleans photoconductor 20.

After that, photoconductor 20 is controlled to rotate in the first direction, the foreign materials are effectively cleaned and ejected from the surface of photoconductor 20. During the rotation in the first rotating direction, photoconductor 20 is rotated for several rotations to tens of rotations. That is, just after foreign material adhered to photoconductor 20, foreign material is cleaned off by cleaning device 100, whereby any foreign material is totally removed from photoconductor 20, and decrease of image quality during subsequent image formation can be prevented.

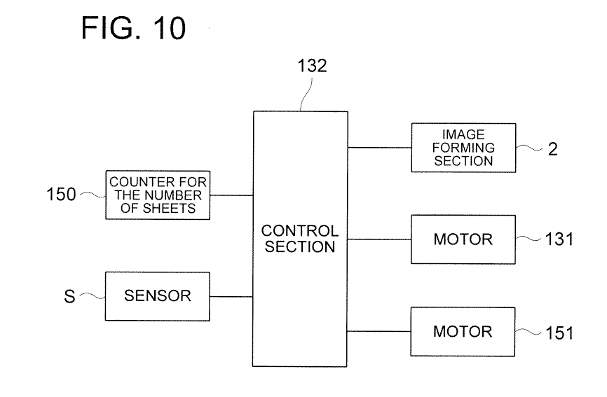

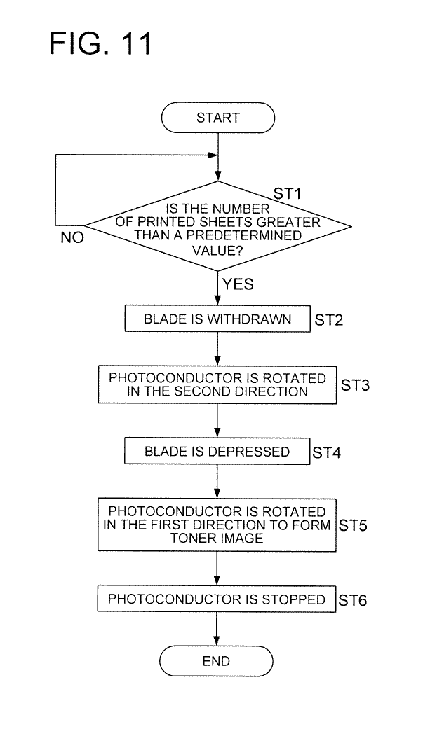

FIG. 10 is a block chart of the control system to control the above-described blade exchanging operation, and FIG. 11 is a flow chart for exchanging the cleaning blade.

Control section 132 controls total operations of image forming apparatus 1, including the image forming operation, and in particular, controls a blade exchanging operation, detailed below.

Control section 132 to conduct the blade exchanging operation shown in FIG. 11, motor 131, and the blade exchanging mechanism shown in FIGS. 3 to 9, are configured to structure a blade exchanging section, wherein the blade exchanging operation is configured to exchange cleaning blade 118, and to conduct a blade exchanging operation shown in FIG. 11, relative to the blade exchange.

In step ST1, print counter 150 is checked whether the printed sheets have reached a predetermined number, for example, 300,000 prints. If the predetermined number has been attained (Yes of ST1), motor 131 is activated in step ST2, so that cleaning blade 118 is retracted to the exchanging position. That is, since cam 127 is set at the angle shown in FIG. 7c, cylindrical pin member 135a separates from ratchet 134 as shown in FIG. 9c, and blade supporting shaft 119 rotates 180 degrees, whereby blade 118 is exchanged. Cam 127 is rotated by motor 131, based on a detection signal from sensor S.

In step ST3, motor 15 is activated to rotate photoconductor 20 in the second rotating direction. Due to this rotation, any foreign material, ejected from cleaning device 100 and adhered to photoconductor 20, moves upstream of cleaning device 100. In step ST3, photoconductor 20 rotates approximately 60 degrees in the second rotating direction, whereby foreign material is shifted upstream of cleaning brush 116. Additionally, in step ST3, after cleaning blade 118 has been retracted, photoconductor 20 is rotated in the second rotating direction, so that foreign material is shifted to an upstream position. However, concerning the starting time of this rotation in the second direction, it is not necessary in this embodiment that after blade 118 has been retracted, photoconductor 20 is rotated in the second rotating direction. That is, before cleaning blade 118 is retracted, photoconductor 20 can be rotated in the second rotating direction.

In step ST4, motor 131 is activated so that cleaning blade 118 comes into pressure contact with photoconductor 20.

In step ST5, image forming section 2 forms toner images on the surface of photoconductor 20, and simultaneously motor 151 is activated to rotate one minute, so that photoconductor 20 is rotated in the first rotating direction. Due to the rotations for one minute, photoconductor 20 is rotated approximately 100 turns so that cleaning operations are conducted approximately 100 times. The cleaning operations of at least 10 times make the surface of photoconductor 20 to be sufficiently cleaned. In step ST5, due to the rotation of photoconductor 20 in the first rotating direction, foreign material, ejected from cleaning device 100, is removed. In addition, since the toner images are formed on the surface of photoconductor 20 in step ST5, cleaning blade 118 becomes more sliding, so that the cleaning operations are conducted more effectively. For example, toner layers formed in step ST5 represent even toner images exhibiting 12.5 mm width (being the length in the rotational direction), which are formed at the interval of 0.5 sec.

In step ST6, the rotation of photoconductor 20, in the first rotating direction, is terminated.

Further, in step ST6, it is more preferable for the cleaning operation that photoconductor 20 is stopped, and simultaneously motor 131 is activated, so that cleaning device 100 is set to the non-cleaning condition, as shown in FIG. 9b.

Concerning the exchanging procedure of the cleaning blade in the embodiment detailed above, the blade exchanging section is configured to retract the cleaning blade which has been used, after that, said used cleaning blade is exchanged for a new cleaning blade.

However, the procedure detailed below can be possible to be used.

Firstly, the blade exchanging section retracts the cleaning blade, which has been used, to the retracted position.

After that, the user conducts the exchanging operation.

The photoconductor is rotated in the second rotating direction, and the new cleaning blade is pressed against the photoconductor.

After that, the photoconductor is rotated in the first rotating direction, so that the cleaning operation is conducted.

Concerning the effects of the invention, when the cleaning blade is to be exchanged, the image carrier is rotated in the second rotating direction, whereby, foreign material, adhered onto the image carrier, is moved upstream of the cleaning blade, after that, the image carrier is rotated in the first rotating direction, so that any foreign material is removed, and the blade exchanging operation is completed.

Due to the above procedure, foreign material, being difficult to be cleaned off, such as external additives, is effectively cleaned off, so that the images exhibiting high image quality can be stably formed over a long time.

What is claimed is:

1. An image forming apparatus comprising:
an image carrier for carrying a toner image,
wherein the image carrier is configured to rotate in a first direction and a second direction, and the second direction is opposite to the first direction;
a transfer device for transferring the toner image, carried on the image carrier rotating in the first direction, onto a recording medium;
a cleaning device comprising a cleaning blade for cleaning the image carrier from which the toner image has been transferred; and
a cleaning blade exchanging section for exchanging the cleaning blade, wherein the image forming apparatus is configured to work in such ways that,
after the cleaning blade exchanging section has retracted the cleaning blade to a retracted position,
the cleaning blade exchanging section rotates the image carrier in the second direction,
so that any foreign material, adhered onto the image carrier while the cleaning blade is exchanged, is moved upstream of the cleaning position of the cleaning blade, with respect to the first direction,
then the cleaning blade, having been exchanged, is pressed against the image carrier, and
then the image carrier is subsequently rotated in the first direction, so that the image carrier is cleaned.

2. The image forming apparatus of claim 1, further comprising
a cleaning brush for cleaning the image carrier, at a position upstream of the cleaning position with respect to the first direction,
wherein when the image carrier is to be rotated in the second direction, the cleaning brush moves the foreign material to an upstream position of the cleaning brush with respect to the first direction.

3. The image forming apparatus of claim 1, wherein the cleaning device includes plural cleaning blades.

4. The image forming apparatus of claim 1, wherein before the cleaning blade has been moved to the retracted position, or after the cleaning blade has been moved to the retracted position, the image carrier is started to rotate in the second direction.

5. The image forming apparatus of claim 1, wherein the cleaning device includes a housing for hermetically sealing the cleaning device other than a portion at which the cleaning device contacts the image carrier.

6. The image forming apparatus of claim 3, wherein the cleaning blade exchanging section includes a cleaning unit on which the plural cleaning blades are mounted, and a spring for rotating the cleaning unit,
wherein the cleaning blade is rotated by a restoring force of the charged spring, whereby the cleaning blade is exchanged.

7. The image forming apparatus of claim 6, wherein the cleaning blade exchanging section is configured to rotate the cleaning unit plural times to exchange the cleaning blade.

8. The image forming apparatus claim 1, further comprising a counter for counting the number of printed sheets, wherein when the number of printed sheets have reached a predetermined number, the cleaning blade exchanging section makes it possible to exchange the cleaning blade.

9. The image forming apparatus of claim 1, wherein the cleaning blade exchanging section exchanges the cleaning blade, after the cleaning blade has been retracted to the retracted position.

10. The image forming apparatus of claim 9, further comprising an auxiliary cleaning member which is arranged downstream of the cleaning blade with respect to the first direction.

11. The image forming apparatus of claim 1, wherein the cleaning blade is possible to be exchanged by a user.
